(19) United States
(12) Patent Application Publication
(10) Pub. No.: US 2017/0298866 A1
(43) Pub. Date: Oct. 19, 2017

(54) METHOD AND APPARATUS FOR COGENERATION POWER PLANT WASTE HEAT SOURCE UTILIZATION BY INCORPORATED WATER SOURCE HIGH TEMPERATURE HEAT PUMP

(71) Applicant: UNIVERSITY OF MARIBOR, Maribor (SI)

(72) Inventors: Darko GORICANEC, Maribor (SI); Jurij KROPE, Orehova vas (SI); Stane BOZICNIK, Maribor (SI)

(21) Appl. No.: 15/516,413

(22) PCT Filed: Sep. 14, 2015
(86) PCT No.: PCT/IB2015/001617

§ 371 Date: Apr. 3, 2017

(30) Foreign Application Priority Data
Oct. 3, 2014 (SI) P-201400339

(51) Int. Cl. F02G 5/04; F24D 19/10; F01K 1/20; F24D 3/18

(52) U.S. Cl. CPC F02G 5/04; F24D 3/18; F24D 19/1039; F01K 1/20; F24D 2200/18; F24D 2200/26; F24H 2240/06; F24D 2200/123

(57) ABSTRACT

The invention relates to a method and apparatus for low temperature waste heat utilization. In the scope of the cogeneration unit (CHP) there are few low temperature sources, which cannot be used by heat consumer (HC) directly. Hence, the method and apparatus for cogeneration power plant waste heat recovery comprise at least one, preferably condensing type heat exchanger (HE2), which collects the waste heat for water source high temperature heat pump (HP) employment, wherein its hot water outlet is fed to the internal combustion engine (ICE) cooling system, i.e. cooling jacket type heat exchanger, wherein the maximum allowed coolant inlet temperature is achieved and maintained by automated control system (i.e. control unit with motorized control valves (V1-V3)). It is important to notice, that low temperature sources are herein represented by the exhaust gas in the scope of exhaust system, the charging air in the scope of the intercooler or turbo-supercharger, and lubrication oil cooling system in the scope of internal combustion engine (ICE) or heat pump (HP).

### FIELD OF INVENTION

The object of this patent application relates to the methods and apparatus for combined heat and power systems waste heat recovery (i.e. cogeneration power plants) wherein incorporated water source high temperature heat pump utilizes at least one waste heat source of cogeneration unit.

### BACKGROUND OF THE INVENTION

Heat pumps that have been used in prior art to enhance the heating power of combined heat and power systems by utilizing the waste heat recovery have been deployed in a number of designs. According to US2006037349 a waste heat is used to improve the heating performance of a heat pump type air conditioner or to prevent an outdoor heat exchanger of the heat pump type air conditioner from being frosted. Yet another solution as disclosed in EP2299098 incorporates an air source type heat pump for utilizing the waste heat source of cogeneration unit, wherein similarly to the one stated before, the main disadvantage of represented approach is relatively low thermal coefficient of performance compared to the water source heat pump potential.

### SUMMARY OF THE INVENTION

This invention relates to the combined heat and power systems, wherein at least one incorporated water source high temperature heat pump is used to upgrade a low temperature heat from at least one waste heat source to the higher temperature heat output, which can be afterwards used by at least one heat consumer for space or process heating, preferably in the scope of district heating. It is important to notice, that the heat pump according to the invention is used to heat up and rise the temperature of a heat transfer medium in a return line of a heat distribution network, wherein a design (i.e. operational) temperature of the heat transfer medium in a forward line of the heat distribution network is substantially higher than 60° C., when operating at normal operating conditions. It can be understood, that operating conditions of the heat distribution network are provided after commissioning and warm-up process where at least basic design temperature of the heat distribution network is successfully achieved and maintained (i.e. established) over at least a short period of time, hence at least one internal combustion engine is turned on and operating by firing the fuel in the combustion process in continuous operation and at least one heat pump is turned on and operating for liquid-vapor phase change thermodynamic cycle process (i.e. heat pump principle) and waste heat source utilization. In accordance, at least one internal combustion engine and at least one heat pump are used to provide a first and second heat source respectively in the scope of heat distribution network where individual unit shall substantially operate in the range between its minimum and maximum rated (i.e. full load) operating power, preferably at normal rated power for highest power developed in continuous operation.

Exemplary embodiment of the present invention will now be described with reference to the accompanying drawing, i.e. schematics of a cogeneration power plant with incorporated water source high temperature heat pump in a heat distribution network (i.e. preferably at least one closed loop circuit heating system).

### BRIEF DESCRIPTION OF THE DRAWING

FIG. 1 shows a schematic representation of combined heat and power plant preferential embodiment with incorporated water source high temperature heat pump (HP) having a condenser and evaporator unit for heat pump principle utilization, where following items are shown and marked: cogeneration unit (CHP) with prime mover, preferably internal combustion engine (ICE) with adapted electrical generator (G), heat distribution circuit comprising a network of pipes (P1-P19), valves (V1-V3) and pumps (PU1-PU4) which interconnects the heat consumer (HC) with heat sources, heat exchangers (HE1-HE3), hatches (H1-H4), fan (F1), external cooling system (CT1), ambient (O) and control temperature sensors (T1-T13).

Referring to the preferential embodiment of the cogeneration unit (CHP) with incorporated water source high temperature heat pump (HP), the system comprises an internal combustion engine (ICE), preferably a water cooled gas engine, which runs on a gas fuel, such as natural gas, liquefied petroleum gas, landfill gas, wood gas or biogas for example. While internal combustion engine (ICE) and generator (G) are used for electricity and heat generation when powered, a significant amount of heat is released from the cylinders within the combustion process and other subcomponents (i.e. lubrication oil, charging air and exhaust gas, hereinafter addressed as flue gas), wherein the heat is either used by heat consumer (HC) rather than dissipated to the ambient (O) through the external cooling system (CT1). It is important to notice, that the main heat source for heat consumer (HC) is preferably represented by internal combustion engine (ICE) cooling system (i.e. a jacket type heat exchanger, having an inlet and outlet aperture, herein addressed as inflow and outflow aperture) whereby plurality of waste heat sources arise in the scope of the cogeneration unit (CHP) and incorporated heat pump (HP) when the internal combustion engine (ICE) and heat pump (HP) are turned on and powered, preferably at optimum efficiency or full load regime.

Effective recovery of waste heat is critical to provide a good total utilization of fuel energy, thus, first and most important waste heat source is represented by flue gas in exhaust system, which is a product of the combustion process within the internal combustion engine (ICE). Secondly, there are at least two additional waste heat sources represented by lubrication oil cooling systems, the first one represented by internal combustion engine (ICE) lubrication oil cooling system and a second one represented by the heat pump (HP) lubrication oil cooling system (i.e. incorporated compressors lubrication oil cooling system). Furthermore, there are few minor waste heat sources, as internal combustion engine (ICE) charging air cooling system for example, which are under certain circumstances still important for good total waste heat source utilization.

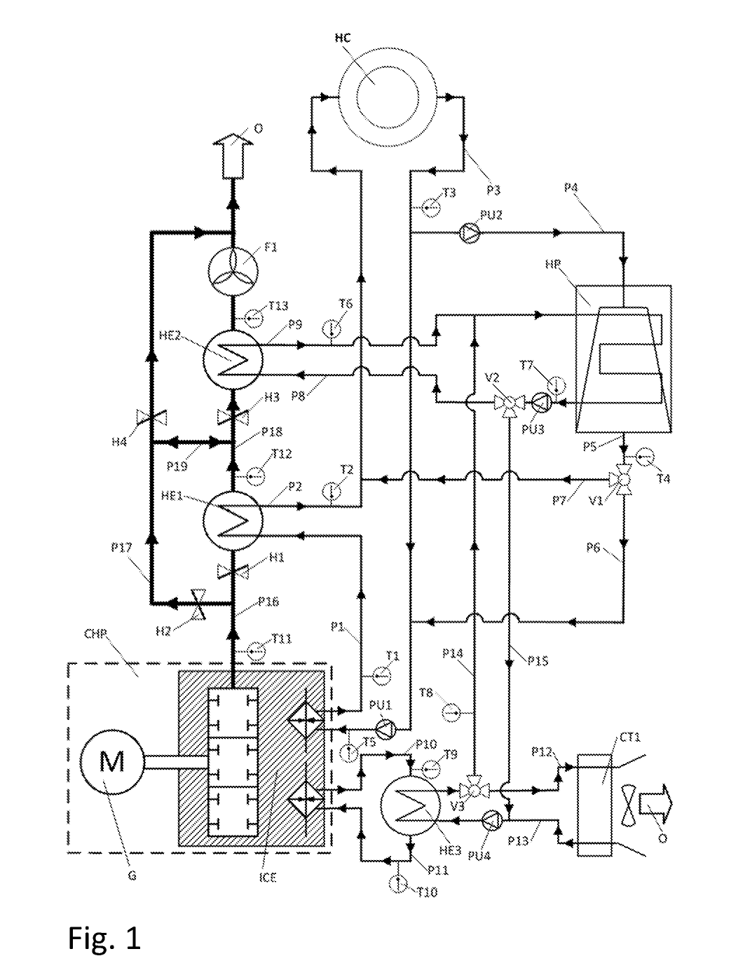

According to the depicted preferential embodiment as represented on FIG. 1, the internal combustion engine (ICE) cooling system inflow and outflow apertures are operably coupled to the heat distribution circuit comprising a network of pipes (P1-P19) that operably interconnects the heat consumer (HC) with heat sources in the scope of cogeneration plant with incorporated water source high temperature heat pump (HP). The heat distribution circuit further comprises a primary heat transfer medium and automated regulation means comprising the control unit (i.e. control electronics), valves (V1-V3) and pumps (PU1-PU4) for primary heat transfer medium flow regulation, wherein the heat of heat sources is preferably transferred to the heat consumer (HC) by principle of primary heat transfer medium circulation in a closed loop heat distribution circuit.

As partially known from prior art, the waste heat of flue gas is utilized by incorporated heat exchanger (HE1) which collects the high temperature waste heat of flue gas in exhaust system, wherein the exhaust heat exchanger (HE1) is capable to collect the waste heat due to the significant temperature difference between the flue gas in exhaust system and primary heat transfer medium in incorporated heat exchanger (HE1). Furthermore, exhaust system according to the invention preferably comprises at least one additional condensing heat exchanger (HE2), which is incorporated to collect at least the residual low temperature waste heat of flue gas, being used afterwards by water source high temperature heat pump (HP) to enhance the heating power of the cogeneration unit (CHP). More precisely, the depicted embodiment comprises two heat exchangers (HE1, HE2) incorporated into the internal combustion engine (ICE) exhaust system with aim to collect the waste heat of combustion process, wherein it is important to notice, that the first heat exchanger (HE1) is operably coupled to the forward line of heat distribution circuit, wherein the flow of primary heat transfer medium through the heat exchanger (HE1) cools down the temperature of flue gas to approximately 120° C.; and furthermore, the second (i.e. preferably condensing) heat exchanger (HE2) is operably coupled with a high temperature heat pump (HP) evaporator unit, preferably in a closed loop piping system with secondary heat transfer medium involved, hence the temperature of the flue gas in exhaust system is additionally reduced to the temperature close to the ambient (O), preferably bellow 25° C. While the temperature of flue gas in exhaust system is rapidly reduced, the exhaust system may further comprise a suction fan (F1) for removal of flue gas from exhaust system, if necessary.

If appropriate, the heating power of represented cogeneration unit (CHP) can be furthermore enhanced if the first heat exchanger (HE1) is partially or completely bypassed by means of flue gas stream manipulation (i.e. regulation) means comprising motorized valves, preferably hatches (H1-H4), regulated by said control unit. It can be understood, that the utilization of flue gas waste heat source is maximized by high temperature heat pump (HP), if the first heat exchanger (HE1) is completely bypassed and hence the stream of the high temperature flue gas is fully enforced through the condensing heat exchanger (HE2), which collects the waste heat required for heat pump (HP) principle utilization. Even more, if appropriate, the heat exchanger (HE2) and heat pump (HP) shall be implemented in a multistage approach or cascade principle comprising a plurality of heat pumps (HP) and/or heat exchangers (HE2) in parallel and/or serial connection, to reach the simplified and cost effective solution for exhaust system as well. As follows, similarly as described for flue gas waste heat utilization, the waste heat of internal combustion engine charging air or lubrication oil cooling system can be collected as well by at least one additional heat exchanger (HE3), which is operably coupled to the heat pump (HP) evaporator unit in serial or parallel connection with above described heat exchanger (HE2) in exhaust system, wherein the lubrication oil cooling system of heat pump (HP) compressor is preferably incorporated into the water source high temperature heat pump (HP) enclosure.

While there are several options for waste heat source utilization it is essential to notice, that preferential embodiment of water source high temperature heat pump (HP) utilization uses at least one low temperature waste heat source for vaporization of working medium of incorporated heat pump (HP), wherein the condenser unit outlet is preferably fed to the heat distribution circuit return line, more precisely to the inflow of the internal combustion engine (ICE) cooling system, where the aim of proposed inventive approach is to reach and maintain the maximum allowed temperature of the primary heat transfer medium at the inlet of the engine cooling system. According to depicted embodiment on FIG. 1 the heat distribution circuit comprises a cooling system bypass connection, hence the cooling system is at least partially bypassed when the maximum allowed temperature of primary heat transfer medium at inflow aperture of the internal combustion engine (ICE) cooling system is reached and successfully maintained at defined set point with hysteresis, wherein the valve (V1) is reconfigured by automated regulation means to a position, which at least partially redirects the primary heat transfer medium stream from condenser unit outlet to the forward line of heat distribution circuit. In addition, the heat distribution circuit further comprises a heat pump (HP) condenser unit bypass connection, wherein the condenser unit is at least partially bypassed according to the heat demand situation in heat distribution circuit.

Furthermore, the invention relates to a method of the heat pump (HP) integration process, to a method for utilization of low grade temperature waste heat sources of cogeneration unit (CHP) by water source high temperature heat pump (HP) and to a method of using the apparatus according to the invention.

The following steps represent the key features of a heat pump (HP) integration and novel method for cogeneration unit (CHP) waste heat source utilization:
1. Integration of the water source high temperature heat pump (HP) having a condenser and evaporator unit with working medium for liquid-vapor phase change thermodynamic cycle utilization and at least one heat exchanger (HE2, HE3), wherein:
   A) the high temperature heat pump (HP) condenser unit is operably coupled to the heat distribution circuit pipeline system; and
   B) the high temperature heat pump (HP) evaporator unit is operably coupled with at least one heat exchanger (HE2, HE3) in a closed loop piping system with secondary heat transfer medium involved.
2. Collecting the heat by incorporated heat exchanger (HE2, HE3) from at least one waste heat source, wherein the heat source is:
   A) Flue gas stream in exhaust system; and/or
   B) Lubrication oil cooling system; and/or
   C) Intercooler charging air.
3. Transfer of the heat from at least one heat source to the high temperature heat pump (HP) evaporator unit, preferably by circulation of secondary heat transfer medium in the closed loop piping system.
4. Transfer of the heat from secondary heat transfer medium to the working medium in evaporator unit of the high temperature heat pump (HP), wherein the low temperature heat from at least one waste heat source is upgraded by working medium liquid-vapor phase change thermodynamic cycle, hence the temperature of the working medium in condenser unit is substantially higher than the temperature of the working medium in evaporator unit.
5. Transfer of the heat from working medium in the high temperature heat pump (HP) to the primary heat transfer medium in the heat distribution circuit, wherein the temperature of the primary heat transfer medium at condenser unit outlet is substantially higher than temperature of the primary heat transfer medium at condenser unit inlet, hence the high temperature output of condenser unit is fed to the:
   A) Internal combustion engine (ICE) cooling system inflow (i.e. return line), wherein the inflow temperature is maintained by automated regulation means (preferably by valves (V1-V3) and pumps (PU1-PU4)) in a range between the 60° C. and 90° C., preferably at set point with 70° C.; and/or
   B) Forward line of the heat distribution circuit with at least one heat consumer (HC) involved.
6. Usage of high temperature primary heat transfer medium by:
   A) Internal combustion engine (ICE) cooling system with aim to maintain the maximum allowed predefined set point of inlet temperature; and/or
   B) Heat consumer (HC) in the scope of the district heating, industrial or technological process.

The following steps represent the key features of a method of using the apparatus according to the invention:
1. A fuel combustion process, where an engine cooling system of at least one internal combustion engine (ICE) is used to provide a first heat releasing unit for heating at least one heat transfer medium in said heat distribution network, wherein at least one waste heat source arise when the internal combustion engine (ICE) is turned on and operating by firing the fuel in the combustion process. Accordingly, plurality of internal combustion engine (ICE) units with engine cooling systems in parallel or serial connection shall be used to provide an advanced edition of the first heat releasing unit.
2. A waste heat recovery process comprises a process of collecting the waste heat, wherein at least one waste heat recovery unit is used to collect at least a portion of the heat of at least one waste heat source from group of waste heat sources comprising a flue gas in exhaust system, charging air in charging air cooling system or lubrication oil in lubrication oil cooling system. Accordingly, plurality of waste heat recovery units in parallel or serial connection shall be used to provide an advanced apparatus for waste heat recovery process utilization.
3. A liquid-vapor phase change thermodynamic cycle utilization process, wherein at least one water source high temperature heat pump (HP) shall be used to provide a second heat releasing unit for heating at least one heat transfer medium in said heat distribution network, at least when said heat pump (HP) is turned on and operating. Accordingly, plurality of heat pumps (HP) units in parallel or serial connection is used to provide an advanced edition of the second heat releasing unit.
4. Usage of collected heat for liquid-vapor phase change utilization, wherein at least a portion of collected heat is used for the liquid-vapor phase change cycle utilization and wherein at least a portion of the heat generated by at least one heat pump (HP) in the scope of the second heat releasing unit is used for heating the engine cooling system of at least one internal combustion engine (ICE) in the scope of the first heat releasing unit.
5. Distribution of the heat in at least one closed loop circuit of said heat distribution network by circulation of at least one heat transfer medium, wherein the lowest temperature of the heat distribution medium in the engine cooling system of at least one internal combustion engine (ICE) in the scope of the first heat releasing unit is substantially higher than the lowest temperature of the heat distribution medium in at least one heat consumer (HC). Hence, at least one heat transfer medium in at least one return line of said heat distribution network is reheated by the heat pump (HP) principle utilization, wherein the temperature of the heat transfer medium in said engine cooling system of at least one internal combustion engine (ICE) is substantially higher than 60° C., at least when a design temperature of the heat distribution network is reached and said internal combustion engine (ICE) and heat pump (HP) are operating at full load.

In addition to represented method of using the apparatus according to the invention, few explanations and definitions are required, wherein combustion process is substantially a continuous process, while said internal combustion engine (ICE) normally operates in the range between its minimum and maximum rated operating power, preferably at normal rated power in continuous operation. Similarly the liquid-vapor phase change thermodynamic cycle utilization process is substantially a continuous process, wherein said heat pump (HP) operates in the range between its minimum and maximum rated operating power, preferably at normal rated power in continuous operation. If appropriate, the fuel combustion process in complex (i.e. advanced) heat and power generation plant shall be provided by plurality of internal combustion engine (ICE) units, wherein the heat in the scope of the first heat releasing unit is transferred in serial and/or in parallel connection with aim to transfer the heat between individual engine cooling systems and similarly, the liquid-vapor phase change thermodynamic cycle utilization process shall be utilized by plurality of heat pump (HP) units to provide a second heat releasing unit of the advanced heat and power generation plant.

While one of the key features of method and apparatus according to the invention is establishment of predetermined set point value for internal combustion engine coolant temperature, the thermal energy balance adjustment is executed by adapting the power of said heat pump (HP) and/or by adapting the power of said internal combustion engine (ICE) and/or by adapting the mass flow of the primary heat transfer medium through the engine cooling system of said internal combustion engine and/or by adapting the mass flow of the primary heat transfer medium through the heat pump (HP) and/or by adapting the mass flow of the secondary heat transfer medium in at least one of said closed loop circuit for waste heat source utilization. Accordingly the mass flow of the primary heat transfer medium in said heat distribution circuit is adapted by changing the flow velocity in said heat distribution circuit and/or the mass flow of the secondary heat transfer medium in said closed loop circuit is adapted by changing the flow velocity in said closed loop circuit, wherein the velocity of heat transfer medium in heat distribution network is adapted by switching (i.e. on/off regulation) and/or by adjusting the power of at least one circulation pump for mass flow adjustment. In addition, the mass flow of the primary heat transfer medium in said heat distribution circuit is alternatively adapted by stream flow regulation, wherein at least a portion of the primary heat transfer medium stream in the return line of said heat distribution circuit is redirected to the return line of said heat distribution circuit to provide a heat pump (HP) bypass connection, and/or wherein at least a portion of the primary heat transfer medium stream from said heat pump (HP) is redirected to a forward line of the heat distribution circuit to provide an engine cooling system bypass connection. Similarly the mass flow of the secondary heat transfer medium in said closed loop circuit for waste heat source utilization is adapted by stream flow regulation, wherein at least a portion of the secondary heat transfer medium stream is redirected in said closed loop circuit to provide a bypass connection for at least one waste heat recovery unit. Accordingly, the mass flow regulation of the primary heat transfer medium and/or the mass flow regulation of the secondary heat transfer medium for thermal energy balance adjustment is determined, controlled and executed by at least one control unit (i.e. electronic controller), wherein the position and/or the state (i.e. open/closed or on/off regulation) of the automated regulation means is adjusted in respect to the heat demand in said heat distribution network.

Apparatus according to the invention further comprises at least one control unit, wherein such a controller shall be autonomous device for thermal management regulation or alternatively, at least basic functions of the thermal management controller for determination process, comparison process and execution process could be incorporated and implemented to the internal combustion engine (ICE) controller or in to the heat pump (HP) controller as well. In the determination process the environment and thermal conditions of heat distribution network is determined by the group of thermal, pressure or other sensors, wherein at least one input from at least one sensor of heat distribution network or internal combustion engine (ICE) is used for comparison process, where at least one value of at least one input parameter (i.e. preferably a temperature of the primary heat transfer medium in engine cooling system) is analyzed and compared to the limiting values, preferably being pre-defined and stored in the control unit. Accordingly the execution process comprises a process of executing instructions stored in control unit to generate appropriate output signal, where at least one parameter for thermal energy balance adjustment is generated, executed and performed by control electronics in cooperation with automated regulation means in order to reach and maintain the threshold set-point value, wherein said threshold value is defined between the maximum value and the minimum value for set point equal value with aim to provide a hysteresis for thermal energy balance adjustment.

It can be understood that control unit (i.e. electronic module) may communicate with various output devices where the temperature of the heat transfer medium in the heat transfer network is determined, controlled and regulated by a group of automated regulation means comprising motorized valves, pumps and sensors, wherein regulation means are preferably adapted to be manipulated by at least one control unit. And furthermore, the heat distribution process in heat distribution network is provided by at least one heat transfer medium, preferably by plurality of heat distribution mediums. Accordingly the heat in said heat transfer network is transferred from first heat releasing unit to the heat consumer (HC) by circulation of the primary heat transfer medium in at least one closed loop circuit, and similarly the heat from waste heat recovery unit is transferred to the heat pump (HP) by circulation of the secondary heat transfer medium in at least one closed loop circuit, wherein the heat upgraded by at least one heat pump (HP) is furthermore transferred from heat pump (HP) condenser unit to the engine cooling system of at least one internal combustion engine (ICE) by said primary heat transfer medium.

Summarizing, the cooling circuits of cogeneration unit (CHP), herein represented as low temperature waste heat sources, are used for utilization of water source high temperature heat pump (HP), wherein its hot water output is preferably used for establishing and maintaining the highest possible or maximum allowed temperature of primary heat transfer medium for internal combustion engine (ICE) cooling system inflow (i.e. cooling jacket inlet). It can be understood, that all vital components of heat distribution circuit are preferably operably coupled for heat transfer medium circulation, wherein the compressor of the incorporated heat pump (HP) shall be driven by electric machine, powered by electricity from grid or generator (G), or alternatively if appropriate, a high temperature heat pumps (HP) compressor shall be mechanically coupled to and driven by internal combustion engine (ICE) as well. Furthermore, as can be clearly read out from previous description, the primary heat transfer medium in preferential embodiment is water and similarly, the secondary heat transfer medium in preferential embodiment is mix of water and glycol.

In the foregoing description those skilled in the art will readily appreciate that modifications may be made to the invention without departing from the concepts disclosed herein. Such modifications are to be considered as included in the following claims, unless these claims expressly state otherwise.

We claim:

1. A method of using a heat and power generation apparatus for heating at least one heat consumer (HC) in a heat distribution network by adopting the principle of a water source high temperature heat pump (HP) for waste heat source utilization, the method comprising:
a fuel combustion process, wherein an engine cooling system of at least one internal combustion engine (ICE) is used to provide a first heat releasing unit for heating at least one heat transfer medium in said heat distribution network and wherein at least one waste heat source arise when the internal combustion engine (ICE) is turned on and operating by firing the fuel in the combustion process;
a waste heat recovery process, wherein at least one waste heat recovery unit is used to collect at least a portion of the heat of at least one waste heat source from group of waste heat sources comprising a flue gas in exhaust system, charging air in charging air cooling system or lubrication oil in lubrication oil cooling system;
a liquid-vapor phase change thermodynamic cycle utilization process, wherein at least one water source high temperature heat pump (HP) is used to provide a second heat releasing unit for heating at least one heat transfer medium in said heat distribution network when said heat pump (HP) is turned on and operating, characterized in that
the heat required for the liquid-vapor phase change cycle utilization is gained fully or in part by said waste heat recovery process, wherein at least a portion of the heat collected in the waste heat recovery process is used for liquid-vapor phase change thermodynamic cycle process utilization, and wherein at least a portion of the heat generated by at least one heat pump (HP) in the scope of the second heat releasing unit is used for heating the engine cooling system of at least one internal combustion engine (ICE) in the scope of the first heat releasing unit;
the heat in at least one closed loop circuit of said heat distribution network is preferably distributed by circulation of at least one heat transfer medium, wherein the lowest temperature of the heat distribution medium in the engine cooling system of at least one internal combustion engine (ICE) in the scope of the first heat releasing unit is substantially higher than the lowest temperature of the heat distribution medium in at least one heat consumer (HC) in the scope of the heat distribution network, hence at least one heat transfer medium in at least one return line of said heat distribution network is reheated by the heat pump (HP) principle utilization, and wherein the temperature of the heat transfer medium in said engine cooling system of at least one internal combustion engine (ICE) is substantially higher than 60° C., at least when a design temperature of the heat distribution network is reached and said internal combustion engine (ICE) and heat pump (HP) are operating at full load.

2. A method as in claim 1 characterized in that
the fuel combustion process is substantially a continuous process, wherein said internal combustion engine (ICE) operates in the range between its minimum and maximum rated operating power, preferably at normal rated power in continuous operation;
the liquid-vapor phase change thermodynamic cycle utilization process is substantially a continuous process, wherein said heat pump (HP) operates in the range between its minimum and maximum rated operating power, preferably at normal rated power in continuous operation;
the waste heat recovery process comprises a process of flue gas condensation, wherein the collected is used for heat pump (HP) principle utilization and wherein the temperature of the flue gas is reduced below 25° C., hence the flue gas in exhaust system is removed by ventilating the exhaust system by incorporated fan (F1);
the waste heat recovery process is used for cooling principle utilization, wherein the heat recovery process is used for cooling the charging air for the fuel combustion process utilization;
the temperature of the heat transfer medium in the heat transfer network is determined, controlled and regulated by a group of automated regulation means comprising valves, pumps and sensors, wherein said regulation means are preferably adapted to be manipulated by at least one control unit.

3. A method as in claim 2 characterized in that
the fuel combustion process is provided by plurality of internal combustion engine (ICE) units, wherein the heat in the scope of the first heat releasing unit is transferred in serial and/or in parallel connection to transfer the heat between engine cooling systems in order to provide a first heat releasing unit;
the liquid-vapor phase change thermodynamic cycle utilization process is provided by plurality of heat pump (HP) units, wherein the heat in the scope of the second heat releasing unit is transferred in serial and/or parallel connection to transfer the heat between heat pump (HP) units in order to provide the second heat releasing unit;
the heat distribution process in heat distribution network is provided by plurality of heat distribution mediums, wherein the heat in said heat transfer network is transferred from first heat releasing unit to the heat consumer (HC) by circulation of primary heat transfer medium in at least one closed loop circuit, wherein the heat from waste heat recovery unit is transferred to the heat pump (HP) by circulation of the secondary heat transfer medium in at least one closed loop circuit, and wherein the heat upgraded by at least one heat pump (HP) is furthermore transferred to the engine cooling system of at least one internal combustion engine (ICE) by said primary heat transfer medium.

4. A method as in claim 3 characterized in that
the temperature of the primary heat transfer medium in the engine cooling system of said internal combustion engine (ICE) is maintained at predetermined set point value, wherein thermal energy balance adjustment is executed by adapting the power of said heat pump (HP) and/or by adapting the power of said internal combustion engine (ICE) and/or by adapting the mass flow of the primary heat transfer medium through the engine cooling system of said internal combustion engine and/or by adapting the mass flow of the primary heat transfer medium through the heat pump (HP) and/or by adapting the mass flow of the secondary heat transfer medium in said closed loop circuit for waste heat source utilization.

5. A method as in claim 4 characterized in that
the mass flow of the primary heat transfer medium in said heat distribution circuit is adapted by changing the flow velocity in said heat distribution circuit and/or the mass flow of the secondary heat transfer medium in said closed loop circuit is adapted by changing the flow velocity in said closed loop circuit, wherein the velocity of heat transfer medium in heat distribution network is adapted by switching and/or by adjusting the power of at least one circulation pump.

6. A method as in claim 4 characterized in that
the mass flow of the primary heat transfer medium in said heat distribution circuit is adapted by stream flow regulation, wherein at least a portion of the primary heat transfer medium stream in the return line of said heat distribution circuit is redirected to the return line of said heat distribution circuit to provide a heat pump (HP) bypass connection, and/or wherein at least a portion of the primary heat transfer medium stream from said heat pump (HP) is redirected to a forward line of the heat distribution circuit to provide an engine cooling system bypass connection;
the mass flow of the secondary heat transfer medium in said closed loop circuit for waste heat source utilization is adapted by stream flow regulation, wherein at least a portion of the secondary heat transfer medium stream is redirected in said closed loop circuit to provide a bypass connection for at least one waste heat recovery unit.

7. A method as in claims 5 and 6 characterized in that
the mass flow regulation of the primary heat transfer medium and/or the mass flow regulation of the secondary heat transfer medium for thermal energy balance adjustment is determined, controlled and executed by said control unit, wherein the position and/or the state of the automated regulation means is adjusted in respect to the heat demand in said heat distribution network.

8. A method for controlling an internal combustion engine and at least one adopted water source high temperature heat pump (HP) to enhance the heating power of an internal combustion engine (ICE) cooling system by a liquid-vapor phase change thermodynamic cycle utilization, the method comprising:
a determination process, wherein at least one input from internal combustion engine (ICE) sensors and/or heat distribution network sensors is determined by at least one control unit for comparison process;
a comparison process, wherein at least one of the inputs from determination process is checked and processed, wherein the value of at least one input parameter is analyzed at least one control unit and compared to the limiting values, preferably defined in said control unit;
an execution process, wherein instructions, preferably stored in at least one control unit, generate appropriate output signal for control of internal combustion engine (ICE) and/or heat pump (HP) and/or heat distribution network automated regulation means adjustment, characterized in that,
at least one parameter to control the power of the internal combustion engine (ICE) and/or the power of the heat pump (HP) and/or the state and/or the position of automated regulation means in heat distribution network is determined for waste heat source utilization and thermal energy balance execution, wherein at least a portion of the heat required for heat pump (HP) principle utilization is gained fully or in part by waste heat recovery process, and wherein at least a portion of the heat generated by the heat pump (HP) is used for reheating a coolant in a return line of the internal combustion engine (ICE) cooling system in order to establish the set-point value of the coolant inlet temperature, wherein the set-point value is substantially higher than 60° C.

9. A method as in claim 8, characterized in that
the heat is distributed in the heat distribution network by circulation of the coolant in function of a primary heat transfer medium, wherein at least a portion of the heat generated by internal combustion engine (ICE) is transferred to at least one heat consumer (HC) through the plurality of closed loop circuits in parallel and/or serial connection, wherein the primary heat transfer medium in the return line of the heat distribution network is reheated by said heat pump (HP) with aim to reach and maintain the threshold value, wherein said threshold value is defined between the maximum value and the minimum value for set point equal value in order to provide a hysteresis for thermal energy balance adjustment;
the heat required for heat pump (HP) principle utilization is gained fully or in part by utilization of at least one from group of waste heat sources comprising a flue gas in exhaust system, charging air in charging air cooling system or lubrication oil in lubrication oil cooling system, wherein utilization of waste heat sources comprises at least two waste heat recovery units, wherein the collected heat is transferred to the heat pump (HP) by circulation of a second heat transfer medium in plurality of closed loop circuits in parallel and/or serial connection, wherein received heat is furthermore upgraded by the heat pump (HP) principle utilization and furthermore transferred to the primary heat transfer medium for heating at least one cooling system of the internal combustion engine (ICE);
the mass flow of the primary heat transfer medium and/or the mass flow of the secondary heat transfer medium is and/or the temperature of at least one heat transfer medium in heat distribution network is determined and regulated by at least one control unit in cooperation with automated regulation means, preferably by motorized valves and pumps, wherein the heat generated by internal combustion engine (ICE) and/or heat pump (HP) and the state and/or the position of the automated regulation means is adjusted by said control unit in respect to the heat demand in said heat distribution network.

10. An apparatus assembly for cogeneration plant waste heat source utilization comprising:
at least one internal combustion engine (ICE) further comprising an engine cooling system, exhaust system, a lubrication oil cooling system and a charging air cooling system, wherein said engine cooling system further comprises at least one inflow aperture and at least one outflow aperture;
at least one water source high temperature heat pump (HP), wherein said heat pump (HP) further comprises a lubrication oil cooling system, an evaporator unit and a condenser unit, and wherein said condenser unit further comprises an inlet aperture and an outlet aperture;
and at least one waste heat recovery unit, preferably a heat exchanger (HE2) adapted to be associated with said evaporator unit in a closed loop circuit characterized in that
said waste heat recovery unit is adapted to be associated with at least one from group of waste heat sources comprising an exhaust system, a lubrication oil cooling system and charging air cooling system for collecting the heat of said waste heat source;
said evaporator unit is adapted to be associated with said waste heat recovery unit in a closed loop circuit for transferring the collected heat from said waste heat recovery unit to said evaporator unit by a secondary heat transfer medium in said closed loop circuit;
said outlet of the condenser unit is adapted to be associated with said inflow of the engine cooling system for transferring the heat of condenser unit to the engine cooling system by a primary heat transfer medium in a heat distribution circuit;
the inlet of said condenser unit and said outflow of the engine cooling system are adapted to be associated with said heat distribution circuit, wherein said heat distribution circuit further comprises at least one thermal energy receiving unit, preferably a heat consumer (HC).

11. The apparatus assembly for cogeneration plant waste heat source utilization as in claim 10 characterized in that
said heat distribution circuit comprises at least one forward line and at least one return line, wherein said forward line and return line interconnects the outflow of said engine cooling system and inlet of said condenser unit via at least one heat consumer (HC), wherein said primary heat transfer medium circulate in said heat distribution circuit to transfer the heat of heat source to the heat consumer (HC);
said outflow of the engine cooling system is operably coupled to the forward line of the heat distribution circuit;
said inlet of the condenser unit is operably coupled to at least one return line of heat distribution circuit;
said outlet of the condenser unit is operably coupled to the inflow of said engine cooling system wherein said heat distribution circuit comprises a primary heat transfer medium; and
said heat exchanger (HE2) is incorporated to said exhaust system to receive at least a portion of the heat of flue gas, wherein said heat exchanger (HE2) is operably coupled to said evaporator unit in the closed loop circuit comprising a secondary heat transfer medium, wherein the heat collected in heat exchanger (HE2) is transferred to the evaporator unit by secondary heat transfer medium circulation in said closed loop circuit, and furthermore, the heat of said condenser unit is transferred to the engine cooling system by primary heat transfer medium circulation in said head distribution circuit, wherein the temperature of said primary heat transfer medium at inflow of said engine cooling system is substantially higher than 60° C. when the internal combustion engine (ICE) and heat pump (HP) are turned on and powered at operating conditions.

12. The apparatus assembly for cogeneration plant waste heat source utilization as in claim 10 characterized in that
said closed loop further comprises an additional heat exchanger (HE3), wherein said additional heat exchanger (HE3) is adapted to be associated with an external cooling system (CT1), wherein said external cooling system (CT1) is adapted to be associated with a lubrication oil cooling system of internal combustion engine (ICE), lubrication oil cooling system of heat pump (HP) and/or internal combustion engine (ICE) charging air cooling system.

13. The apparatus assembly for cogeneration plant waste heat source utilization as in claims 11 and 12 characterized in that
said heat distribution circuit comprises a plurality of the heat consumers (HC) in parallel connection and/or in serial connection;
said heat distribution circuit comprises a plurality of the heat pumps (HP) in parallel connection and/or in serial connection, wherein closed loop circuit of said evaporator unit comprises a plurality of heat exchangers (HE2, HE3) in parallel connection and/or in serial connection, and wherein at least one of the condenser unit outlet aperture is operably coupled to the inflow of said internal combustion engine (ICE) cooling system.

14. The apparatus assembly for cogeneration plant waste heat source utilization as in claim 13 characterized in that
said internal combustion engine (ICE) is designed as a gas fueled engine which runs on a gas fuel selected from group comprising a natural gas, liquefied petroleum gas, landfill gas, wood gas or biogas, wherein said engine cooling system is designed as an engine jacket cooling system of said internal combustion engine (ICE); the primary heat transfer medium in preferential embodiment is water; the secondary heat transfer medium in preferential embodiment is mix of water and glycol; and at least one of said heat exchanger (HE2) is designed as a condensing heat exchanger (HE2), wherein exhaust system further comprises at least one fan (F1) for flue gas extraction.

15. A control unit for controlling an internal combustion engine (ICE) with incorporated heat pump (HP) for cogeneration plant waste heat source utilization, characterized by at least one closed loop heating system for reheating a heat transfer medium according to any of claims 1-14.

16. A control unit for controlling a heat pump (HP) incorporated to an internal combustion engine (ICE) for enhancing a heating power of an engine cooling system characterized by at least one closed loop heating system for reheating a heat transfer medium according to any of claims 1-14.

17. A control unit for cogeneration plant heat distribution regulation, characterized by at least one closed loop heating system for reheating a heat transfer medium according to any of claims 1-14.

18. Local community heating network and/or district heating network, characterized by at least one closed loop heating system for reheating a heat transfer medium according to any of claims 1-14.
